(19) United States
(12) Patent Application Publication
(10) Pub. No.: US 2007/0177981 A1
(43) Pub. Date: Aug. 2, 2007

(54) Nozzle blade airfoil profile for a turbine

(75) Inventors: Thomas W. Vandeputte, Simpsonville, SC (US); John E. Greene, Greenville, SC (US); Peter C. Selent, Taylors, SC (US); Linda J. Farral, Greenville, SC (US); Sze Bun Brian Chan, Greer, SC (US); Brian P. Arness, Simpsonville, SC (US)

Correspondence Address: NIXON & VANDERHYE P.C., 901 NORTH GLEBE ROAD, 11TH FLOOR, ARLINGTON, VA, 22203, US

(73) Assignee: General Electric Company, Schenectady, NY (US)

(21) Appl. No.: 11/340,577

(22) Filed: Jan. 27, 2006

(51) Int. Cl. B64C 27/46

(52) U.S. Cl. 416/223 R

(57) ABSTRACT

First stage stator vanes for a turbine comprised airfoil profile substantially in accordance with Cartesian coordinate values of X, Y and Z set forth in inches in Table I, which define a plurality of radially spaced profile sections forming the nominal profile. The Z coordinate values for each profile section are radial distances from the turbine axis to a portion of the surface of revolution about the axis containing the profile section. The X and Y values for each profile section are coordinate values which, when connected by smooth continuing arcs define the airfoil profile section along the surface of revolution portion. The radially spaced profile sections are joined smoothly with one another to form the nominal airfoil profile.

### BACKGROUND OF THE INVENTION

The present invention relates to a turbine and particularly relates to a nozzle blade airfoil profile for a gas turbine, particularly, the first stage nozzle blade profile.

The hot gas path of a turbine requires nozzle blade profiles that meet system requirements of efficiency and loading. The airfoil shape of the nozzle blades must optimize the interaction between other stages in the turbine, provide for aerodynamic efficiency and optimize aerodynamic life objectives. Particularly, nozzle blade airfoil profile affects nozzle stage positional stability and part life. Accordingly, there is a need for a nozzle airfoil profile which optimizes these objectives.

### BRIEF SUMMARY OF THE INVENTION

In a preferred embodiment of the present invention, there is provided a nozzle blade for a turbine having an airfoil, the airfoil having an uncoated nominal profile substantially in accordance with Cartesian coordinate values of X, Y and Z set forth in inches in Table I which define a plurality of radially spaced profile sections forming the nominal profile, the Z coordinate values for each profile section being radial distances from the turbine axis to a portion of a surface of revolution about the turbine axis containing the profile section, and the X and Y values for each profile section being coordinate values which, when connected by smooth continuing arcs define the airfoil profile section along the surface of revolution portion, the radially spaced profile sections being joined smoothly with one another to form the nominal airfoil profile.

In a further preferred embodiment of the present invention, there is provided a nozzle blade for a turbine having an airfoil, the airfoil having a shape in an envelope within ±0.160 inches in a direction normal to any airfoil surface location, the airfoil having an uncoated nominal profile substantially in accordance with Cartesian coordinate values of X, Y and Z set forth in inches in Table I which define a plurality of radially spaced profile sections forming the nominal profile, the Z coordinate values for each profile section being radial distances from the turbine axis to a portion of a surface of revolution about the turbine axis containing the profile section, and the X and Y values for each profile section being coordinate values which, when connected by smooth continuing arcs define the airfoil profile section along the surface of revolution portion, the radially spaced profile sections being joined smoothly with one another to form the nominal airfoil profile.

In an even further preferred embodiment of the present invention, there is provided a turbine having a plurality of nozzle blades forming a portion of a turbine stage, each nozzle blade being in the shape of an airfoil, each airfoil having an uncoated nominal profile substantially in accordance with Cartesian coordinate values of X, Y and Z set forth in inches in Table I which define a plurality of radially spaced profile sections forming the nominal profile, the Z coordinate values for each profile section being radial distances from the turbine axis to a portion of a surface of revolution about the turbine axis containing the profile section, and the X and Y values for each profile section being coordinate values which, when connected by smooth continuing arcs define the airfoil profile section along the surface of revolution portion, the radially spaced profile sections being joined smoothly with one another to form the nominal airfoil profile.

In still another aspect of the present invention, a turbine having a plurality of nozzle blades forming a portion of a turbine stage, each nozzle blade being in the shape of an airfoil, each the airfoil having an uncoated nominal profile substantially in accordance with Cartesian coordinate values of X, Y and Z set forth in inches in Table I which define a plurality of radially spaced profile sections forming the nominal profile, the Z coordinate values for each profile section being radial distances from the turbine axis to a portion of a surface of revolution about the turbine axis containing the profile section, and the X and Y values for each profile section being coordinate values which, when connected by smooth continuing arcs define the airfoil profile section along the surface of revolution portion, the radially spaced profile sections being joined smoothly with one another to form the nominal airfoil profile, each airfoil having a shape within ±0.0160 inches in a direction normal to any airfoil surface location.

### BRIEF DESCRIPTION OF THE DRAWING

FIG. 1 is a fragmentary schematic cross-sectional view of a turbine illustrating a first stage thereof including a nozzle blade having an airfoil profile according to a preferred embodiment of the present invention;

FIG. 2 is a perspective view of a nozzle segment for the first stage of the turbine illustrating the airfoil hereof; and

FIG. 3 is a schematic illustration of the nozzle airfoil illustrating the location of the profile sections for the X, Y and Z coordinates of Table I which follows.

### DETAILED DESCRIPTION OF THE DRAWINGS

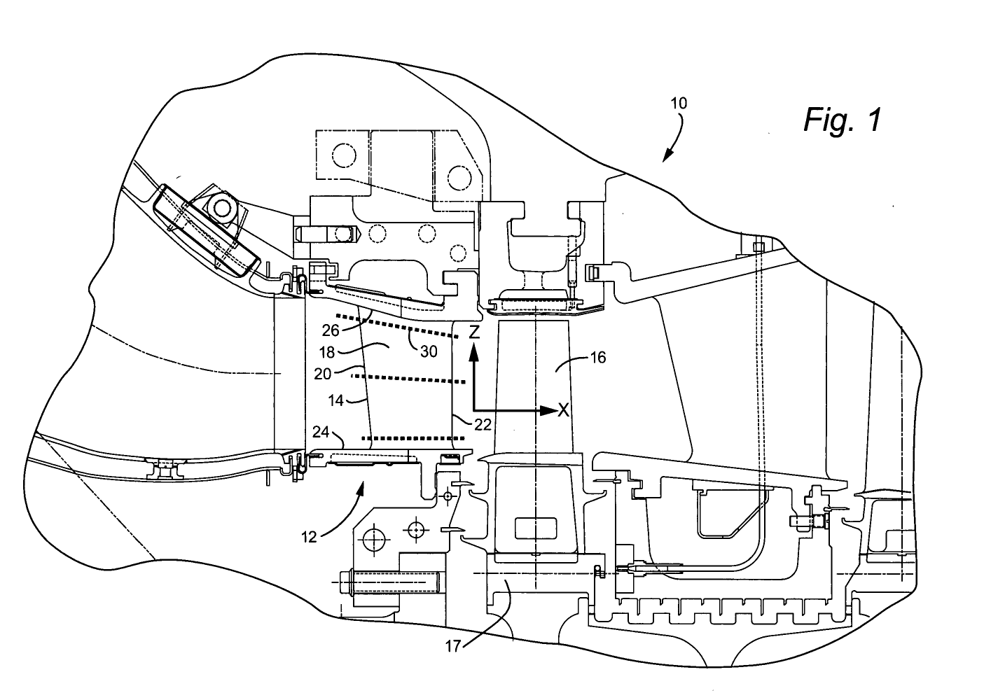

Referring now to FIG. 1, there is illustrated a portion of a turbine, generally designated 10, having multiple stages, including a first stage, generally designated 12. The first stage includes a plurality of circumferentially spaced nozzles 14, as well as buckets 16 mounted on the rotor 17. The first stage nozzles 14 have a plurality of circumferentially spaced airfoils or blades 18 of a particular airfoil shape or profile as specified below.

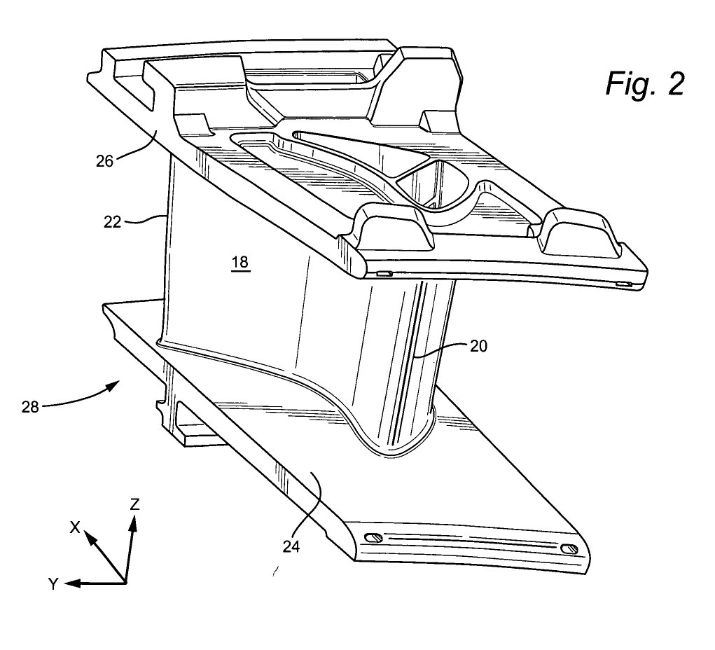

Referring to FIGS. 1 and 2, the airfoil shape or profile of each nozzle airfoil includes leading and trailing edges 20 and 22, respectively. The nozzle airfoils are disposed between inner and outer side walls 24 and 26, respectively. The side walls and the airfoil between the sidewalls constitute a nozzle segment generally designated 28 in FIG. 2. In the preferred and illustrated embodiment of the first stage nozzle, there are forty-eight circumferentially spaced blades and hence forty-eight segments 28.

Each of the first stage nozzle blades has an airfoil profile defined by a Cartesian coordinate system of X, Y and Z values. The coordinate values are set forth in inches in Table I below. The Cartesian coordinate system includes orthogonally related X, Y and Z axes. The X axis lies along the turbine rotor center line, i.e., the rotor axis. The Z axis extends along radii from the center line of the turbine rotor to the X and Y coordinate values for the respective sets of X, Y and Z coordinate values. That is, each Z distance commences at zero along the turbine axis and extends to a point defined by the X and Y coordinate values for those X, Y and Z coordinate values.

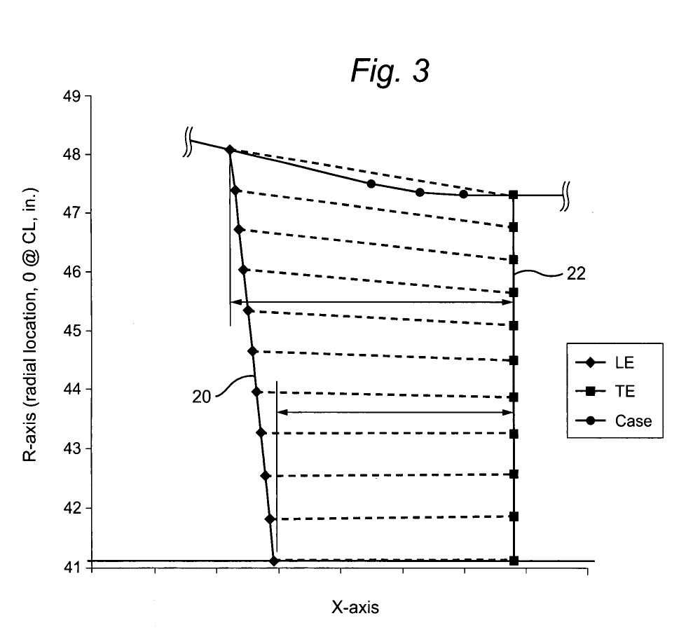

The airfoil profile sections between the inner and outer side walls are given in eleven sets of X, Y and Z coordinate values, and hence eleven profile sections, represented by the dashed lines in FIG. 3. Each profile section lies in and conforms to a portion of a surface of revolution about the turbine axis. For example, as illustrated in FIG. 1 by the dashed outermost-line 30, the profile section at that location for a single airfoil lies in a portion of a conical surface of revolution about the turbine axis. The profile section per se extends in both an arcuate circumferential direction and a longitudinal direction along the surface portion of the conical surface of revolution about the turbine axis. The profile sections defined by the X, Y and Z coordinate values of Table I are therefore not planar but have an arcuate extent in the circumferential direction. Because the profile sections are not taken in planes perpendicular to the turbine axis, the Z coordinate values are different from one another within each set of X, Y and Z coordinate values for each profile section.

By defining X and Y coordinate values at selected locations in the Z direction along radii from the turbine axis, the profile of each airfoil section of the eleven sections can be ascertained. By connecting the X, Y and Z values in each profile section with smooth continuing arcs, the profile of the blade at each section is ascertained. The surface profiles at the various surface locations between the profile sections are connected smoothly to one another to form a nominal airfoil profile.

The tabular values given in Table I are in inches and represent the airfoil profiles at ambient, non-operating or non-hot conditions and are for an uncoated airfoil. The X, Y and Z coordinate values given in Table I are in scientific notation represented by the letter E followed by numerical values. The numerical values represent the number of spaces to move the decimal point of the number preceding the scientific notation E to give the actual value in inches. The plus or minus signs indicate the direction of movement of the decimal points, i.e., the plus sign signals movement of the decimal point to the right and the minus sign signals movement of the decimal point to the left. The 78 points defined by the X, Y and Z coordinate values of Table I for each profile section are for a nominal cold or room temperature profile for each profile section of the airfoil.

There are typical manufacturing tolerances as well as coatings which must be accounted for in the actual profile of the airfoil. Accordingly, the values for the profile given in Table I are for a nominal airfoil. It will therefore be appreciated that typical manufacturing tolerances, i.e., ±values and coating thicknesses are added to or subtracted from the X, Y and Z values given in Table I below. Accordingly, a distance of ±0.160 inches in a direction normal to any surface location along the airfoil profile, defines an airfoil envelope for this particular airfoil design. In a preferred embodiment, the blade airfoil profiles given in Table I below are for the first stage blades of the turbine.

The coordinate values given in Table I below are in inches and provides the preferred nominal profile envelope.

TABLE I

| X | Y | Z |
|---|---|---|
| −7.91400E−01, | 2.19440E+00, | 4.62400E+01 |
| −1.46860E+00, | −7.08000E−02, | 4.63382E+01 |
| −2.49950E+00, | −1.61540E+00, | 4.64562E+01 |
| −3.00010E+00, | −1.75920E+00, | 4.71098E+01 |
| −3.58100E+00, | −1.66730E+00, | 4.66623E+01 |
| −1.17520E+00, | 8.28900E−01, | 4.63053E+01 |
| −2.18940E+00, | −1.31720E+00, | 4.69255E+01 |
| −1.90340E+00, | −9.35900E−01, | 4.68823E+01 |
| −1.64400E+00, | −5.10500E−01, | 4.63543E+01 |
| −1.68200E+00, | −5.11500E−01, | 4.68609E+01 |
| −3.75040E+00, | −1.58720E+00, | 4.66998E+01 |
| −2.94070E+00, | −1.76720E+00, | 4.65327E+01 |
| −1.34690E+00, | 3.85000E−01, | 4.68318E+01 |
| −3.81010E+00, | −1.57810E+00, | 4.73251E+01 |
| −9.36900E−01, | 1.76060E+00, | 4.67806E+01 |
| −1.31550E+00, | 3.77100E−01, | 4.63226E+01 |
| −2.13820E+00, | −1.31390E+00, | 4.64057E+01 |
| −1.04270E+00, | 1.28290E+00, | 4.62860E+01 |
| −3.40410E+00, | −1.72810E+00, | 4.66244E+01 |
| −1.06760E+00, | 1.30040E+00, | 4.68006E+01 |
| −3.64020E+00, | −1.65790E+00, | 4.72780E+01 |
| −1.20340E+00, | 8.41500E−01, | 4.68172E+01 |
| −1.85960E+00, | −9.32000E−01, | 4.63743E+01 |
| −1.50310E+00, | −6.75000E−02, | 4.68456E+01 |
| −2.55740E+00, | −1.61370E+00, | 4.70003E+01 |
| −8.09800E−01, | 2.22150E+00, | 4.67578E+01 |
| −9.15200E−01, | 1.73830E+00, | 4.62645E+01 |
| −3.46300E+00, | −1.71840E+00, | 4.72298E+01 |
| −4.12760E+00, | −1.37460E+00, | 4.74133E+01 |
| −3.24230E+00, | 3.58900E−01, | 4.72028E+01 |
| −4.27560E+00, | −1.25610E+00, | 4.74547E+01 |
| −4.41700E+00, | −1.12900E+00, | 4.74944E+01 |
| −2.93770E+00, | 5.19600E−01, | 4.71239E+01 |
| −3.97260E+00, | −1.48270E+00, | 4.73701E+01 |
| −4.65190E+00, | −3.36500E−01, | 4.75671E+01 |
| −4.56290E+00, | −2.28000E−01, | 4.75448E+01 |
| −4.55230E+00, | −9.94700E−01, | 4.75322E+01 |
| −4.68450E+00, | −3.99400E−01, | 4.75750E+01 |
| −4.08030E+00, | 4.35000E−02, | 4.74210E+01 |
| −3.56180E+00, | 2.31200E−01, | 4.72860E+01 |
| −4.70810E+00, | −4.66300E−01, | 4.75804E+01 |
| −3.82180E+00, | 1.40400E−01, | 4.73543E+01 |
| −4.33070E+00, | −7.49000E−02, | 4.74855E+01 |
| −3.69170E+00, | 1.85600E−01, | 4.73200E+01 |
| −4.66900E+00, | −8.43600E−01, | 4.75652E+01 |
| −4.72700E+00, | −6.10600E−01, | 4.75837E+01 |
| −4.70530E+00, | −7.54200E−01, | 4.75760E+01 |
| −4.70810E+00, | −4.66300E−01, | 4.75804E+01 |
| −3.95160E+00, | 9.37000E−02, | 4.73879E+01 |
| −4.20700E+00, | −1.21000E−02, | 4.74537E+01 |
| −4.72430E+00, | −6.59000E−01, | 4.75823E+01 |
| −4.69760E+00, | −4.32900E−01, | 4.75780E+01 |
| −4.45030E+00, | −1.45800E−01, | 4.75161E+01 |
| −4.61110E+00, | −2.79000E−01, | 4.75570E+01 |
| −4.66930E+00, | −3.67300E−01, | 4.75713E+01 |
| −4.71870E+00, | −5.12600E−01, | 4.75827E+01 |
| −4.72520E+00, | −5.61800E−01, | 4.75838E+01 |
| −1.95140E+00, | 1.48070E+00, | 4.68752E+01 |
| −1.90400E+00, | 1.45400E+00, | 4.63668E+01 |
| −1.04790E+00, | 2.95140E+00, | 4.62099E+01 |
| −4.91700E−01, | 3.33630E+00, | 4.61655E+01 |
| −1.22700E+00, | 2.67560E+00, | 4.67495E+01 |
| −2.11350E+00, | 1.17970E+00, | 4.64054E+01 |
| −5.62100E−01, | 3.14460E+00, | 4.67036E+01 |
| −4.32900E−01, | 3.56480E+00, | 4.61481E+01 |
| −1.56730E+00, | 2.06430E+00, | 4.68061E+01 |
| −1.20160E+00, | 2.64220E+00, | 4.62393E+01 |
| −1.39280E+00, | 2.36750E+00, | 4.67768E+01 |
| −4.35360E+00, | −1.14010E+00, | 4.68374E+01 |
| −2.59710E+00, | 6.89500E−01, | 4.64965E+01 |
| −2.16550E+00, | 1.20630E+00, | 4.69234E+01 |
| −6.23400E−01, | 2.91380E+00, | 4.67183E+01 |
| −2.39930E+00, | 9.49800E−01, | 4.69808E+01 |
| −6.85100E−01, | 2.68300E+00, | 4.67322E+01 |
| −2.65620E+00, | 7.18200E−01, | 4.70470E+01 |
| −2.34330E+00, | 9.22500E−01, | 4.64484E+01 |
| −2.87670E+00, | 4.89100E−01, | 4.65516E+01 |
| −5.01200E−01, | 3.37560E+00, | 4.66882E+01 |
| −4.21310E+00, | −1.26610E+00, | 4.68047E+01 |
| −3.17970E+00, | 3.27400E−01, | 4.66111E+01 |
| −5.50900E−01, | 3.10780E+00, | 4.61819E+01 |
| −3.91190E+00, | −1.49170E+00, | 4.67359E+01 |
| −1.06810E+00, | 2.98760E+00, | 4.67231E+01 |
| −1.53120E+00, | 2.03530E+00, | 4.63000E+01 |
| −6.10300E−01, | 2.87940E+00, | 4.61976E+01 |
| −1.36210E+00, | 2.33640E+00, | 4.62692E+01 |
| −8.99600E−01, | 3.26330E+00, | 4.61812E+01 |
| −4.40500E−01, | 3.60660E+00, | 4.66720E+01 |
| −1.71090E+00, | 1.74040E+00, | 4.63322E+01 |
| −3.74400E−01, | 3.79340E+00, | 4.61299E+01 |
| −6.70200E−01, | 2.65100E+00, | 4.62126E+01 |
| −1.75260E+00, | 1.76800E+00, | 4.68386E+01 |
| −4.06600E+00, | −1.38400E+00, | 4.67710E+01 |
| −3.80200E−01, | 3.83750E+00, | 4.66550E+01 |
| −3.20000E−01, | 4.06850E+00, | 4.66372E+01 |
| −3.02400E−01, | 4.56410E+00, | 4.60606E+01 |
| −4.10500E−01, | 4.41760E+00, | 4.66029E+01 |
| −4.58550E+00, | −3.57400E−01, | 4.68989E+01 |
| −4.61780E+00, | −4.19400E−01, | 4.69052E+01 |
| −4.26640E+00, | −9.92000E−02, | 4.68329E+01 |
| −4.48810E+00, | −1.00720E+00, | 4.68688E+01 |
| −4.64130E+00, | −4.85300E−01, | 4.69096E+01 |
| −4.49730E+00, | −2.50200E−01, | 4.68809E+01 |
| −6.22700E−01, | 3.93770E+00, | 4.66432E+01 |
| −5.51500E−01, | 4.09740E+00, | 4.66298E+01 |
| −4.80800E−01, | 4.25740E+00, | 4.66163E+01 |
| −6.94600E−01, | 3.77830E+00, | 4.66564E+01 |
| −2.48400E−01, | 4.56670E+00, | 4.60610E+01 |
| −3.40600E−01, | 4.57790E+00, | 4.65893E+01 |
| −4.08600E−01, | 4.36720E+00, | 4.60790E+01 |
| −3.25100E−01, | 4.54850E+00, | 4.60619E+01 |
| −7.67200E−01, | 3.61920E+00, | 4.66698E+01 |
| −4.63090E+00, | −4.52500E−01, | 4.69077E+01 |
| −2.06900E−01, | 4.53220E+00, | 4.60652E+01 |
| −4.63920E+00, | −7.69200E−01, | 4.69054E+01 |
| −2.24400E−01, | 4.55340E+00, | 4.60628E+01 |
| −4.66030E+00, | −6.27500E−01, | 4.69119E+01 |
| −8.40700E−01, | 3.46050E+00, | 4.66830E+01 |
| −4.65180E+00, | −5.30900E−01, | 4.69114E+01 |
| −4.01660E+00, | 1.67000E−02, | 4.67812E+01 |
| −6.15100E−01, | 3.89250E+00, | 4.61234E+01 |
| −5.45800E−01, | 4.05050E+00, | 4.61087E+01 |
| −2.48400E−01, | 4.56670E+00, | 4.60610E+01 |
| −2.58000E−01, | 4.25030E+00, | 4.60912E+01 |
| −4.60270E+00, | −3.87800E−01, | 4.69023E+01 |
| −3.02300E−01, | 4.61630E+00, | 4.65868E+01 |
| −1.98400E−01, | 4.50620E+00, | 4.60679E+01 |
| −2.48100E−01, | 4.61880E+00, | 4.65886E+01 |
| −4.38550E+00, | −1.69000E−01, | 4.68577E+01 |
| −3.49860E+00, | 2.00300E−01, | 4.66749E+01 |
| −2.48100E−01, | 4.61880E+00, | 4.65886E+01 |
| −4.54510E+00, | −3.00600E−01, | 4.68907E+01 |
| −2.00100E−01, | 4.47880E+00, | 4.60705E+01 |
| −4.14300E+00, | −3.77000E−02, | 4.68073E+01 |
| −9.15300E−01, | 3.30230E+00, | 4.66964E+01 |
| −6.85100E−01, | 3.73470E+00, | 4.61379E+01 |
| −2.60000E−01, | 4.29950E+00, | 4.66187E+01 |
| −4.77000E−01, | 4.20870E+00, | 4.60940E+01 |
| −2.00100E−01, | 4.53050E+00, | 4.65994E+01 |
| −2.75600E−01, | 4.57050E+00, | 4.60603E+01 |
| −8.27100E−01, | 3.42000E+00, | 4.61668E+01 |
| −3.40400E−01, | 4.52570E+00, | 4.60641E+01 |
| −7.55700E−01, | 3.57720E+00, | 4.61525E+01 |
| −2.75400E−01, | 4.62270E+00, | 4.65871E+01 |
| −3.62830E+00, | 1.55300E−01, | 4.67015E+01 |
| −3.25100E−01, | 4.60070E+00, | 4.65876E+01 |
| −3.16100E−01, | 4.02180E+00, | 4.61110E+01 |
| −4.65770E+00, | −6.75200E−01, | 4.69108E+01 |
| −2.06700E−01, | 4.58400E+00, | 4.65938E+01 |
| −4.65840E+00, | −5.79400E−01, | 4.69121E+01 |
| −1.98300E−01, | 4.55790E+00, | 4.65968E+01 |
| −4.64130E+00, | −4.85300E−01, | 4.69096E+01 |
| −2.24100E−01, | 4.60540E+00, | 4.65910E+01 |
| −4.60350E+00, | −8.57500E−01, | 4.68962E+01 |
| −3.88800E+00, | 6.57000E−02, | 4.67547E+01 |
| −3.75830E+00, | 1.11200E−01, | 4.67283E+01 |
| −7.73900E−01, | 2.16110E+00, | 4.57051E+01 |
| −1.22960E+00, | 3.13400E−01, | 4.46542E+01 |
| −3.85190E+00, | −1.50240E+00, | 4.60981E+01 |
| −1.74550E+00, | −9.65600E−01, | 4.46764E+01 |
| −1.57530E+00, | −5.34800E−01, | 4.52522E+01 |
| −3.46620E+00, | −1.68990E+00, | 4.54126E+01 |
| −9.95600E−01, | 1.22860E+00, | 4.51979E+01 |
| −3.73390E+00, | −1.52470E+00, | 4.48058E+01 |
| −8.74100E−01, | 1.67650E+00, | 4.51779E+01 |
| −1.25760E+00, | 3.38000E−01, | 4.52298E+01 |
| −1.82080E+00, | −9.39500E−01, | 4.58311E+01 |
| −3.23720E+00, | −1.76320E+00, | 4.47594E+01 |
| −1.01900E+00, | 1.25730E+00, | 4.57510E+01 |
| −3.34700E+00, | −1.74000E+00, | 4.60128E+01 |
| −2.83180E+00, | −1.79200E+00, | 4.53420E+01 |
| −1.37510E+00, | −1.23400E−01, | 4.46631E+01 |
| −3.63340E+00, | −1.60910E+00, | 4.54340E+01 |
| −1.28640E+00, | 3.59300E−01, | 4.57866E+01 |
| −2.35160E+00, | −1.64810E+00, | 4.46998E+01 |
| −2.04930E+00, | −1.33080E+00, | 4.52793E+01 |
| −1.43700E+00, | −8.47000E−02, | 4.58011E+01 |
| −2.44770E+00, | −1.62460E+00, | 4.58898E+01 |
| −1.09700E+00, | 7.54100E−01, | 4.46422E+01 |
| −3.41070E+00, | −1.70100E+00, | 4.47745E+01 |
| −8.94600E−01, | 1.70880E+00, | 4.57296E+01 |
| −1.78260E+00, | −9.50700E−01, | 4.52635E+01 |
| −3.79250E+00, | −1.51350E+00, | 4.54555E+01 |
| −1.60950E+00, | −5.20700E−01, | 4.58150E+01 |
| −7.39600E−01, | 2.08680E+00, | 4.45881E+01 |
| −3.52310E+00, | −1.67860E+00, | 4.60414E+01 |
| −1.12250E+00, | 7.82200E−01, | 4.52151E+01 |
| −2.00770E+00, | −1.34380E+00, | 4.46853E+01 |
| −1.54190E+00, | −5.52500E−01, | 4.46699E+01 |
| −2.78130E+00, | −1.80440E+00, | 4.47254E+01 |
| −7.56500E−01, | 2.12520E+00, | 4.51544E+01 |
| −1.14870E+00, | 8.07200E−01, | 4.57699E+01 |
| −9.72800E−01, | 1.19710E+00, | 4.46274E+01 |
| −3.29130E+00, | −1.75190E+00, | 4.53914E+01 |
| −2.88520E+00, | −1.77940E+00, | 4.59448E+01 |
| −1.40570E+00, | −1.02300E−01, | 4.52417E+01 |
| −3.69140E+00, | −1.59810E+00, | 4.60699E+01 |
| −8.54100E−01, | 1.64150E+00, | 4.46096E+01 |
| −2.39810E+00, | −1.63560E+00, | 4.53033E+01 |
| −3.57630E+00, | −1.62010E+00, | 4.47900E+01 |
| −2.09300E+00, | −1.32070E+00, | 4.58542E+01 |
| −1.17980E+00, | 2.60480E+00, | 4.57053E+01 |
| −2.81980E+00, | 4.58100E−01, | 4.59677E+01 |
| −2.06920E+00, | 1.14970E+00, | 4.58559E+01 |
| −3.12030E+00, | 2.96200E−01, | 4.60116E+01 |
| −3.94420E+00, | −1.40610E+00, | 4.54768E+01 |
| −2.49340E+00, | 6.28100E−01, | 4.53381E+01 |
| −3.68800E−01, | 3.74650E+00, | 4.55923E+01 |
| −4.15070E+00, | −1.27750E+00, | 4.61525E+01 |
| −4.00480E+00, | −1.39480E+00, | 4.61257E+01 |
| −1.47230E+00, | 1.96640E+00, | 4.52043E+01 |
| −1.64330E+00, | 1.67470E+00, | 4.52302E+01 |
| −5.40000E−01, | 3.06680E+00, | 4.56459E+01 |
| −4.25600E−01, | 3.51990E+00, | 4.56110E+01 |
| −5.97700E−01, | 2.84030E+00, | 4.56619E+01 |
| −1.50090E+00, | 2.00190E+00, | 4.57634E+01 |
| −1.67610E+00, | 1.70850E+00, | 4.57930E+01 |
| −2.76570E+00, | 4.26900E−01, | 4.53687E+01 |
| −2.54380E+00, | 6.59100E−01, | 4.59268E+01 |
| −1.01320E+00, | 2.86990E+00, | 4.51243E+01 |
| −2.29440E+00, | 8.92600E−01, | 4.58898E+01 |
| −4.22740E+00, | −1.16520E+00, | 4.55180E+01 |
| −3.06330E+00, | 2.65400E−01, | 4.54004E+01 |
| −6.55900E−01, | 2.61380E+00, | 4.56772E+01 |
| −2.24820E+00, | 8.61500E−01, | 4.53098E+01 |
| −1.82730E+00, | 1.39080E+00, | 4.52563E+01 |
| −1.15920E+00, | 2.56530E+00, | 4.51515E+01 |
| −1.86440E+00, | 1.42330E+00, | 4.58237E+01 |
| −4.82600E−01, | 3.29330E+00, | 4.56289E+01 |
| −1.03010E+00, | 2.91170E+00, | 4.56762E+01 |
| −1.31160E+00, | 2.26380E+00, | 4.51782E+01 |
| −2.02750E+00, | 1.11810E+00, | 4.52829E+01 |
| −4.29030E+00, | −1.15240E+00, | 4.61784E+01 |
| −4.08890E+00, | −1.28940E+00, | 4.54976E+01 |
| −1.33610E+00, | 2.30120E+00, | 4.57344E+01 |
| −3.76470E+00, | 1.25000E−02, | 4.54775E+01 |
| −2.07200E−01, | 4.47940E+00, | 4.55255E+01 |
| −3.25300E−01, | 4.49510E+00, | 4.55242E+01 |
| −4.51790E+00, | −5.67600E−01, | 4.55660E+01 |
| −3.63610E+00, | 5.56000E−02, | 4.54627E+01 |
| −3.82570E+00, | 3.88000E−02, | 4.61184E+01 |
| −4.41330E+00, | −3.43000E−01, | 4.55549E+01 |
| −6.08400E−01, | 3.84490E+00, | 4.55887E+01 |
| −4.46960E+00, | −4.28200E−01, | 4.55613E+01 |
| −4.01740E+00, | −8.62000E−02, | 4.55072E+01 |
| −4.25700E+00, | −2.13500E−01, | 4.55360E+01 |
| −4.50670E+00, | −8.00200E−01, | 4.55610E+01 |
| −1.98600E−01, | 4.45340E+00, | 4.55281E+01 |
| −3.56690E+00, | 1.26200E−01, | 4.60784E+01 |
| −4.59140E+00, | −5.97100E−01, | 4.62392E+01 |
| −4.52650E+00, | −6.61800E−01, | 4.55659E+01 |
| −3.43760E+00, | 1.70300E−01, | 4.60588E+01 |
| −4.57430E+00, | −5.04200E−01, | 4.62374E+01 |
| −4.53790E+00, | −8.72100E−01, | 4.62257E+01 |
| −4.49720E+00, | −4.91300E−01, | 4.55642E+01 |
| −4.59090E+00, | −6.91800E−01, | 4.62377E+01 |
| −2.00100E−01, | 4.42600E+00, | 4.55307E+01 |
| −4.51910E+00, | −3.78000E−01, | 4.62293E+01 |
| −2.76100E−01, | 4.51730E+00, | 4.55218E+01 |
| −6.76600E−01, | 3.68850E+00, | 4.56036E+01 |
| −4.55100E+00, | −4.39100E−01, | 4.62342E+01 |
| −4.20260E+00, | −1.22600E−01, | 4.61783E+01 |
| −3.12300E−01, | 3.97300E+00, | 4.55727E+01 |
| −2.56100E−01, | 4.19950E+00, | 4.55521E+01 |
| −4.57430E+00, | −5.04200E−01, | 4.62374E+01 |
| −4.43190E+00, | −2.71900E−01, | 4.62155E+01 |
| −7.45400E−01, | 3.53240E+00, | 4.56185E+01 |
| −3.95380E+00, | −8.90000E−03, | 4.61386E+01 |
| −4.36010E+00, | −1.03470E+00, | 4.55377E+01 |
| −2.48800E−01, | 4.51370E+00, | 4.55221E+01 |
| −3.69650E+00, | 8.31000E−02, | 4.60983E+01 |
| −4.47240E+00, | −8.87000E−01, | 4.55551E+01 |
| −8.15000E−01, | 3.37650E+00, | 4.56331E+01 |
| −8.85600E−01, | 3.22110E+00, | 4.56476E+01 |
| −4.73700E−01, | 4.15830E+00, | 4.55581E+01 |
| −4.50740E+00, | −5.23100E−01, | 4.55652E+01 |
| −4.50740E+00, | −5.23100E−01, | 4.55652E+01 |
| −4.52420E+00, | −7.08500E−01, | 4.55649E+01 |
| −3.02800E−01, | 4.51080E+00, | 4.55225E+01 |
| −4.45270E+00, | −3.98500E−01, | 4.55594E+01 |
| −4.52450E+00, | −6.14800E−01, | 4.55663E+01 |
| −4.48430E+00, | −4.58900E−01, | 4.55629E+01 |
| −4.13940E+00, | −1.45600E−01, | 4.55217E+01 |
| −4.47910E+00, | −3.21900E−01, | 4.62230E+01 |
| −3.40500E−01, | 4.47230E+00, | 4.55266E+01 |
| −4.36660E+00, | −2.93500E−01, | 4.55494E+01 |
| −2.24700E−01, | 4.50040E+00, | 4.55234E+01 |
| −4.53610E+00, | −4.08100E−01, | 4.62319E+01 |
| −4.58480E+00, | −5.49300E−01, | 4.62386E+01 |
| −3.89210E+00, | −3.41000E−02, | 4.54923E+01 |
| −4.32110E+00, | −1.91400E−01, | 4.61975E+01 |
| −4.57290E+00, | −7.84600E−01, | 4.62333E+01 |
| −4.59340E+00, | −6.44600E−01, | 4.62389E+01 |
| −5.40800E−01, | 4.00150E+00, | 4.55734E+01 |
| −3.50710E+00, | 9.77000E−02, | 4.54485E+01 |
| −4.42400E+00, | −1.02070E+00, | 4.62037E+01 |
| −4.07980E+00, | −6.21000E−02, | 4.61586E+01 |
| −4.56400E+00, | −4.71900E−01, | 4.62359E+01 |
| −2.48800E−01, | 4.51370E+00, | 4.55221E+01 |
| −4.07000E−01, | 4.31530E+00, | 4.55424E+01 |
| −3.37850E+00, | 1.40900E−01, | 4.54344E+01 |
| −3.63300E−01, | 3.69810E+00, | 4.50435E+01 |
| −4.18300E−01, | 3.47330E+00, | 4.50621E+01 |
| −5.29200E−01, | 3.02380E+00, | 4.50966E+01 |
| −5.85200E−01, | 2.79900E+00, | 4.51124E+01 |
| −5.73100E−01, | 2.75560E+00, | 4.45488E+01 |
| −8.59800E−01, | 3.13100E+00, | 4.45300E+01 |
| −2.71520E+00, | 3.95900E−01, | 4.47552E+01 |
| −5.18700E−01, | 2.97870E+00, | 4.45338E+01 |
| −9.97400E−01, | 2.82630E+00, | 4.45549E+01 |
| −1.61340E+00, | 1.63920E+00, | 4.46478E+01 |
| −3.88410E+00, | −1.41780E+00, | 4.48218E+01 |
| −6.28000E−01, | 2.53260E+00, | 4.45629E+01 |
| −1.44610E+00, | 1.92900E+00, | 4.46257E+01 |
| −4.16460E+00, | −1.17850E+00, | 4.48530E+01 |
| −3.32190E+00, | 1.12100E−01, | 4.48002E+01 |
| −3.00950E+00, | 2.35000E−01, | 4.47771E+01 |
| −2.20600E+00, | 8.29700E−01, | 4.47119E+01 |
| −1.79340E+00, | 1.35690E+00, | 4.46696E+01 |
| −1.14000E+00, | 2.52380E+00, | 4.45793E+01 |
| −6.41800E−01, | 2.57430E+00, | 4.51274E+01 |
| −4.64800E−01, | 3.20190E+00, | 4.45177E+01 |
| −3.58000E−01, | 3.64820E+00, | 4.44829E+01 |
| −1.98950E+00, | 1.08550E+00, | 4.46911E+01 |
| −4.02740E+00, | −1.30180E+00, | 4.48375E+01 |
| −2.44690E+00, | 5.96800E−01, | 4.47331E+01 |
| −4.73600E−01, | 3.24850E+00, | 4.50799E+01 |
| −1.28900E+00, | 2.22440E+00, | 4.46030E+01 |
| −4.11200E−01, | 3.42500E+00, | 4.45008E+01 |
| −4.44020E+00, | −5.42100E−01, | 4.48903E+01 |
| −4.67700E−01, | 4.05330E+00, | 4.44483E+01 |
| −4.44020E+00, | −5.42100E−01, | 4.48903E+01 |
| −4.45730E+00, | −7.25500E−02, | 4.48893E+01 |
| −3.08700E−01, | 3.92280E+00, | 4.50239E+01 |
| −4.45720E+00, | −6.32800E−01, | 4.48907E+01 |
| −4.41730E+00, | −4.78700E−01, | 4.48889E+01 |
| −4.07660E+00, | −1.68400E−01, | 4.48604E+01 |
| −2.49300E−01, | 4.45970E+00, | 4.49735E+01 |
| −2.76600E−01, | 4.46320E+00, | 4.49733E+01 |
| −1.98800E−01, | 4.34500E+00, | 4.44205E+01 |
| −4.30140E+00, | −3.15000E−01, | 4.48797E+01 |
| −4.29620E+00, | −1.04920E+00, | 4.48680E+01 |
| −3.83140E+00, | −5.89000E−02, | 4.48398E+01 |
| −4.70600E−01, | 4.10650E+00, | 4.50098E+01 |
| −2.25600E−01, | 4.39180E+00, | 4.44157E+01 |
| −4.45070E+00, | −5.86200E−01, | 4.48907E+01 |
| −2.49800E−01, | 4.40470E+00, | 4.44144E+01 |
| −6.60700E−01, | 3.59100E+00, | 4.44906E+01 |
| −5.31500E−01, | 3.89910E+00, | 4.44628E+01 |
| −3.03800E−01, | 4.40120E+00, | 4.44146E+01 |
| −3.95570E+00, | −1.10000E−01, | 4.48502E+01 |
| −1.98700E−01, | 4.39970E+00, | 4.49793E+01 |
| −7.26200E−01, | 3.43730E+00, | 4.45041E+01 |
| −3.40700E−01, | 4.41780E+00, | 4.49784E+01 |
| −2.25200E−01, | 4.44660E+00, | 4.49747E+01 |
| −3.03200E−01, | 4.45660E+00, | 4.49742E+01 |
| −3.05100E−01, | 3.87130E+00, | 4.44640E+01 |
| −4.40290E+00, | −4.48400E−01, | 4.48878E+01 |
| −4.04200E−01, | 4.20770E+00, | 4.44336E+01 |
| −4.19310E+00, | −2.35600E−01, | 4.48704E+01 |
| −5.36000E−01, | 3.95110E+00, | 4.50250E+01 |
| −3.44940E+00, | 6.98000E−02, | 4.48097E+01 |
| −4.44020E+00, | −8.16200E−01, | 4.48861E+01 |
| −4.34740E+00, | −3.64100E−01, | 4.48834E+01 |
| −4.45940E+00, | −6.79200E−01, | 4.48902E+01 |
| −8.72300E−01, | 3.17700E+00, | 4.50972E+01 |
| −2.00000E−01, | 4.31760E+00, | 4.44232E+01 |
| −2.49300E−01, | 4.45970E+00, | 4.49735E+01 |
| −2.52400E−01, | 4.09450E+00, | 4.44441E+01 |
| −6.68400E−01, | 3.64060E+00, | 4.50547E+01 |
| −3.57740E+00, | 2.88000E−02, | 4.48193E+01 |
| −4.43010E+00, | −5.10700E−01, | 4.48897E+01 |
| −3.26100E−01, | 4.38520E+00, | 4.44161E+01 |
| −8.03500E−01, | 3.33120E+00, | 4.50832E+01 |
| −2.77100E−01, | 4.40810E+00, | 4.44140E+01 |
| −7.92600E−01, | 3.28400E+00, | 4.45172E+01 |
| −2.07800E−01, | 4.37090E+00, | 4.44179E+01 |
| −2.00000E−01, | 4.37230E+00, | 4.49820E+01 |
| −4.05500E−01, | 4.26220E+00, | 4.49942E+01 |
| −2.07500E−01, | 4.42560E+00, | 4.49768E+01 |
| −5.95900E−01, | 3.74500E+00, | 4.44768E+01 |
| −7.35500E−01, | 3.48580E+00, | 4.50691E+01 |
| −2.49800E−01, | 4.40470E+00, | 4.44144E+01 |
| −3.70500E+00, | −1.34000E−02, | 4.48295E+01 |
| −4.40670E+00, | −9.02300E−01, | 4.48814E+01 |
| −3.41000E−01, | 4.36220E+00, | 4.44185E+01 |
| −6.02000E−01, | 3.79570E+00, | 4.50400E+01 |
| −2.54200E−01, | 4.14760E+00, | 4.50034E+01 |
| −4.38620E+00, | −4.19000E−01, | 4.48866E+01 |
| −3.25600E−01, | 4.44070E+00, | 4.49760E+01 |
| −1.88140E+00, | −1.39520E+00, | 4.27838E+01 |
| −1.66920E+00, | −1.00350E+00, | 4.34393E+01 |
| −3.46230E+00, | −1.64260E+00, | 4.34699E+01 |
| −1.04260E+00, | 6.89700E−01, | 4.34324E+01 |
| −3.18380E+00, | −1.77440E+00, | 4.41145E+01 |
| −1.13730E+00, | 2.23400E−01, | 4.27987E+01 |
| −6.84500E−01, | 1.95700E+00, | 4.27584E+01 |
| −9.24100E−01, | 1.12590E+00, | 4.34225E+01 |
| −3.35550E+00, | −1.71200E+00, | 4.41249E+01 |
| −1.96650E+00, | −1.35920E+00, | 4.40706E+01 |
| −1.43360E+00, | −6.22200E−01, | 4.27962E+01 |
| −2.63310E+00, | −1.84250E+00, | 4.27781E+01 |
| −1.07080E+00, | 7.23200E−01, | 4.40474E+01 |
| −2.26070E+00, | −1.67660E+00, | 4.34368E+01 |
| −1.50770E+00, | −5.73300E−01, | 4.40656E+01 |
| −2.73200E+00, | −1.81690E+00, | 4.40925E+01 |
| −1.30990E+00, | −2.74300E−01, | 4.34418E+01 |
| −7.89100E−01, | 1.52140E+00, | 4.27745E+01 |
| −1.20080E+00, | 2.85800E−01, | 4.40566E+01 |
| −3.24420E+00, | −1.73460E+00, | 4.27863E+01 |
| −3.13020E+00, | −1.78580E+00, | 4.34561E+01 |
| −3.40450E+00, | −1.65410E+00, | 4.27905E+01 |
| −9.49300E−01, | 1.16270E+00, | 4.40351E+01 |
| −1.92450E+00, | −1.37630E+00, | 4.34369E+01 |
| −1.70810E+00, | −9.83500E−01, | 4.40676E+01 |
| −8.11700E−01, | 1.56360E+00, | 4.34089E+01 |
| −3.51940E+00, | −1.63120E+00, | 4.41357E+01 |
| −2.21470E+00, | −1.69240E+00, | 4.27781E+01 |
| −8.33600E−01, | 1.60380E+00, | 4.40194E+01 |
| −1.01330E+00, | 6.54100E−01, | 4.27943E+01 |
| −1.16970E+00, | 2.55700E−01, | 4.34390E+01 |
| −3.30010E+00, | −1.72330E+00, | 4.34627E+01 |
| −1.62890E+00, | −1.02560E+00, | 4.27904E+01 |
| −1.47140E+00, | −5.96700E−01, | 4.34416E+01 |
| −8.98100E−01, | 1.08690E+00, | 4.27864E+01 |
| −2.68270E+00, | −1.82960E+00, | 4.34437E+01 |
| −1.27470E+00, | −2.03200E−01, | 4.27992E+01 |
| −1.34370E+00, | −1.47500E−01, | 4.40624E+01 |
| −2.30620E+00, | −1.66180E+00, | 4.40772E+01 |
| −3.07620E+00, | −1.79710E+00, | 4.27828E+01 |
| −2.66640E+00, | 3.64800E−01, | 4.41253E+01 |
| −2.16530E+00, | 7.97000E−01, | 4.40942E+01 |
| −3.76360E+00, | −1.44220E+00, | 4.34860E+01 |
| −5.98800E−01, | 2.44180E+00, | 4.33696E+01 |
| −5.47400E−01, | 2.66180E+00, | 4.33572E+01 |
| −1.72780E+00, | 1.28460E+00, | 4.34335E+01 |
| −2.95710E+00, | 2.04800E−01, | 4.41394E+01 |
| −5.60700E−01, | 2.70980E+00, | 4.39635E+01 |
| −2.40210E+00, | 5.64900E−01, | 4.41097E+01 |
| −1.55510E+00, | 1.56320E+00, | 4.34197E+01 |
| −6.13900E−01, | 2.48830E+00, | 4.39767E+01 |
| −4.10170E+00, | −1.19230E+00, | 4.41819E+01 |
| −1.58440E+00, | 1.60190E+00, | 4.40436E+01 |
| −7.03600E−01, | 2.00250E+00, | 4.33913E+01 |
| −3.82400E+00, | −1.42980E+00, | 4.41588E+01 |
| −3.96300E−01, | 3.32170E+00, | 4.33138E+01 |
| −1.76070E+00, | 1.32150E+00, | 4.40613E+01 |
| −3.61660E+00, | −1.54790E+00, | 4.34778E+01 |
| −1.91630E+00, | 1.01640E+00, | 4.34466E+01 |
| −1.10190E+00, | 2.43490E+00, | 4.33704E+01 |
| −4.46200E−01, | 3.10170E+00, | 4.33293E+01 |
| −3.96590E+00, | −1.31460E+00, | 4.41704E+01 |
| −7.22200E−01, | 2.04580E+00, | 4.40000E+01 |
| −5.08000E−01, | 2.93130E+00, | 4.39493E+01 |
| −4.03900E−01, | 3.37450E+00, | 4.39180E+01 |
| −2.61800E+00, | 3.33300E−01, | 4.34791E+01 |
| −2.12470E+00, | 7.63300E−01, | 4.34582E+01 |
| −1.24440E+00, | 2.14000E+00, | 4.33883E+01 |
| −1.95300E+00, | 1.05160E+00, | 4.40783E+01 |
| −1.42060E+00, | 1.88990E+00, | 4.40252E+01 |
| −1.12120E+00, | 2.48030E+00, | 4.39850E+01 |
| −4.96600E−01, | 2.88170E+00, | 4.33437E+01 |
| −3.90400E+00, | −1.32780E+00, | 4.34944E+01 |
| −4.55800E−01, | 3.15290E+00, | 4.39342E+01 |
| −1.39480E+00, | 1.84900E+00, | 4.34046E+01 |
| −1.26690E+00, | 2.18310E+00, | 4.40057E+01 |
| −2.90510E+00, | 1.74600E−01, | 4.34871E+02 |
| −3.67540E+00, | −1.53610E+00, | 4.41472E+01 |
| −4.03840E+00, | −1.20640E+00, | 4.35026E+01 |
| −2.35750E+00, | 5.32400E−01, | 4.34689E+01 |
| −3.64580E+00, | −3.89000E−02, | 4.41722E+01 |
| −3.04300E−01, | 4.34380E+00, | 4.38337E+01 |
| −2.50300E−01, | 4.34770E+00, | 4.38340E+01 |
| −4.36270E+00, | −5.30300E−01, | 4.42109E+01 |
| −2.08400E−01, | 4.25520E+00, | 4.32360E+01 |
| −3.26630E+00, | 8.36000E−02, | 4.41539E+01 |
| −2.97500E−01, | 3.76190E+00, | 4.32797E+01 |
| −7.70400E−01, | 3.18310E+00, | 4.33204E+01 |
| −4.30580E+00, | −8.49200E−01, | 4.35212E+01 |
| −2.00000E−01, | 4.20200E+00, | 4.32415E+01 |
| −3.51930E+00, | 2.20000E−03, | 4.41658E+01 |
| −7.07300E−01, | 3.33410E+00, | 4.33093E+02 |
| −3.39260E+00, | 4.22000E−02, | 4.41598E+01 |
| −3.26900E−01, | 4.26780E+00, | 4.32322E+01 |
| −4.31480E+00, | −6.23900E−01, | 4.35254E+01 |
| −2.26000E−01, | 4.33490E+00, | 4.38356E+02 |
| −4.31940E+00, | −4.39700E−01, | 4.42091E+01 |
| −4.02900E−01, | 4.15110E+00, | 4.38514E+01 |
| −4.32370E+00, | −7.14800E−01, | 4.35243E+01 |
| −5.83300E−01, | 3.63680E+00, | 4.32859E+01 |
| −3.52500E−01, | 3.59610E+00, | 4.39008E+01 |
| −6.53000E−01, | 3.53920E+00, | 4.39047E+01 |
| −4.26810E+00, | −4.89200E−01, | 4.35253E+01 |
| −9.81700E−01, | 2.78040E+00, | 4.39632E+01 |
| −3.83250E+00, | −1.57300E−01, | 4.35119E+01 |
| −3.01400E−01, | 3.81770E+00, | 4.38826E+01 |
| −4.16750E+00, | −1.07930E+00, | 4.35108E+01 |
| −9.65700E−01, | 2.73270E+00, | 4.33513E+01 |
| −2.50900E−01, | 4.28850E+00, | 4.32318E+01 |
| −5.27000E−01, | 3.84490E+00, | 4.38788E+01 |
| −4.06480E+00, | −2.79800E−01, | 4.35195E+01 |
| −2.78300E−01, | 4.29140E+00, | 4.32309E+01 |
| −4.21440E+00, | −4.06700E−01, | 4.35240E+01 |
| −2.08100E−01, | 4.31410E+00, | 4.38380E+01 |
| −3.58670E+00, | −6.45000E−02, | 4.35043E+01 |
| −3.26500E−01, | 4.32760E+00, | 4.38350E+01 |
| −4.37270E+00, | −5.61300E−01, | 4.42112E+01 |
| −2.48600E−01, | 3.98200E+00, | 4.32611E+01 |
| −4.34060E+00, | −9.17900E−01, | 4.42032E+01 |
| −4.29460E+00, | −5.50100E−01, | 4.35256E+01 |
| −4.61700E−01, | 3.94040E+00, | 4.32609E+01 |
| −4.38990E+00, | −7.42700E−01, | 4.42096E+01 |
| −2.00000E−01, | 4.26090E+00, | 4.38432E+01 |
| −4.38960E+00, | −6.50900E−01, | 4.42110E+01 |
| −4.35010E+00, | −4.98600E−01, | 4.42105E+01 |
| −4.01390E+00, | −1.91300E−01, | 4.41924E+01 |
| −2.50300E−01, | 4.34770E+00, | 4.38340E+01 |
| −4.37270E+00, | −5.61300E−01, | 4.42112E+01 |
| −4.23600E+00, | −3.36500E−01, | 4.42049E+01 |
| −2.77700E−01, | 4.35080E+00, | 4.38333E+01 |
| −1.99200E−01, | 4.22940E+00, | 4.32388E+01 |
| −3.77100E+00, | −8.35000E−02, | 4.41789E+01 |
| −5.89700E−01, | 3.69200E+00, | 4.38919E+01 |
| −4.64800E−01, | 3.99800E+00, | 4.38653E+01 |
| −7.81700E−01, | 3.23460E+00, | 4.39291E+01 |
| −3.41600E−01, | 4.24450E+00, | 4.32341E+01 |
| −4.25200E+00, | −4.60500E−01, | 4.35250E+01 |
| −2.50900E−01, | 4.28850E+00, | 4.32318E+01 |
| −6.45000E−01, | 3.48530E+00, | 4.32978E+01 |
| −3.21100E+00, | 5.53000E−02, | 4.34947E+01 |
| −3.41300E−01, | 4.30450E+00, | 4.38372E+01 |
| −4.30450E+00, | −5.80600E−01, | 4.35256E+01 |
| −8.47300E−01, | 3.08280E+00, | 4.39408E+01 |
| −7.17000E−01, | 3.38670E+00, | 4.39171E+01 |
| −3.04800E−01, | 4.28420E+00, | 4.32310E+01 |
| −4.38300E+00, | −6.04900E−01, | 4.42113E+01 |
| −4.32130E+00, | −6.69300E−01, | 4.35250E+01 |
| −1.99000E−01, | 4.28830E+00, | 4.38406E+01 |
| −3.95090E+00, | −2.14200E−01, | 4.35158E+01 |
| −4.27390E+00, | −9.33900E−01, | 4.35183E+01 |
| −4.16990E+00, | −3.58300E−01, | 4.35228E+01 |
| −4.32180E+00, | −7.60100E−01, | 4.35235E+01 |
| −2.26500E−01, | 4.27580E+00, | 4.32335E+01 |
| −2.50500E−01, | 4.03930E+00, | 4.38635E+01 |
| −3.46150E+00, | −2.43000E−02, | 4.35009E+01 |
| −3.89420E+00, | −1.33600E−01, | 4.41857E+01 |
| −3.71060E+00, | −1.08000E−01, | 4.35081E+01 |
| −3.33600E+00, | 1.48000E−02, | 4.34978E+01 |
| −4.28220E+00, | −5.18800E−01, | 4.35255E+01 |
| −4.37340E+00, | −8.32600E−01, | 4.42069E+01 |
| −4.30450E+00, | −5.80600E−01, | 4.35256E+01 |
| −4.39180E+00, | −6.96900E−01, | 4.42105E+01 |
| −4.33580E+00, | −4.68700E−01, | 4.42099E+01 |
| −5.22300E−01, | 3.78850E+00, | 4.32735E+01 |
| −8.34500E−01, | 3.03250E+00, | 4.33311E+01 |
| −4.01500E−01, | 4.09240E+00, | 4.32477E+01 |
| −4.23210E+00, | −1.06400E+00, | 4.41931E+01 |
| −4.12920E+00, | −2.57600E−01, | 4.41989E+01 |
| −3.46700E−01, | 3.54180E+00, | 4.32973E+01 |
| −4.28110E+00, | −3.85300E−01, | 4.42072E+01 |
| −2.56980E+00, | 3.01400E−01, | 4.28158E+01 |
| −3.88400E−01, | 3.26670E+00, | 4.26852E+01 |
| −5.83500E−01, | 2.39320E+00, | 4.27382E+01 |
| −2.08420E+00, | 7.28800E−01, | 4.28034E+01 |
| −1.08250E+00, | 2.38770E+00, | 4.27326E+01 |
| −1.69490E+00, | 1.24660E+00, | 4.27854E+01 |
| −1.87970E+00, | 9.80300E−01, | 4.27952E+01 |
| −5.33900E−01, | 2.61150E+00, | 4.27265E+01 |
| −4.36500E−01, | 3.04830E+00, | 4.27000E+01 |
| −9.49400E−01, | 2.68290E+00, | 4.27155E+01 |
| −2.85320E+00, | 1.44200E−01, | 4.28189E+01 |
| −2.31310E+00, | 4.99300E−01, | 4.28102E+01 |
| −1.52570E+00, | 1.52300E+00, | 4.27745E+01 |
| −1.22180E+00, | 2.09520E+00, | 4.27482E+01 |
| −3.84140E+00, | −1.34140E+00, | 4.28068E+01 |
| −4.84900E−01, | 2.82990E+00, | 4.27139E+01 |
| −1.36890E+00, | 1.80660E+00, | 4.27621E+01 |
| −3.97430E+00, | −1.22090E+00, | 4.28126E+01 |
| −3.70250E+00, | −1.45490E+00, | 4.28011E+01 |
| −3.55710E+00, | −1.55990E+00, | 4.27955E+01 |
| −3.40800E−01, | 3.48530E+00, | 4.26693E+01 |
| −3.88730E+00, | −2.37300E−01, | 4.28279E+01 |
| −2.78900E−01, | 4.22950E+00, | 4.26039E+01 |
| −4.25290E+00, | −7.77900E−01, | 4.28280E+01 |
| −4.18370E+00, | −4.81600E−01, | 4.28310E+01 |
| −4.25210E+00, | −6.88000E−01, | 4.28295E+01 |
| −8.21500E−01, | 2.98020E+00, | 4.26972E+01 |
| −2.51500E−01, | 4.22690E+00, | 4.26051E+01 |
| −4.20630E+00, | −9.50100E−01, | 4.28237E+01 |
| −4.10310E+00, | −3.80300E−01, | 4.28305E+01 |
| −3.40340E+00, | −5.09000E−02, | 4.28225E+01 |
| −6.36900E−01, | 3.42920E+00, | 4.26665E+01 |
| −3.64980E+00, | −1.32700E−01, | 4.28249E+01 |
| −2.46600E−01, | 3.92230E+00, | 4.26344E+01 |
| −4.21340E+00, | −5.39200E−01, | 4.28309E+01 |
| −4.58500E−01, | 3.88050E+00, | 4.26319E+01 |
| −4.23540E+00, | −6.00300E−01, | 4.28305E+01 |
| −3.41800E−01, | 4.18210E+00, | 4.26066E+01 |
| −3.05400E−01, | 4.22210E+00, | 4.26038E+01 |
| −7.59100E−01, | 3.12960E+00, | 4.26874E+01 |
| −2.51500E−01, | 4.22690E+00, | 4.26051E+01 |
| −1.99300E−01, | 4.16820E+00, | 4.26126E+01 |
| −3.27930E+00, | −1.27000E−02, | 4.28217E+01 |
| −3.15560E+00, | 2.68000E−02, | 4.28210E+01 |
| −5.76800E−01, | 3.57950E+00, | 4.26555E+01 |
| −2.27000E−01, | 4.21440E+00, | 4.26071E+01 |
| −4.23740E+00, | −8.66100E−01, | 4.28260E+01 |
| −4.00000E−01, | 4.03130E+00, | 4.26194E+01 |
| −4.19950E+00, | −5.09900E−01, | 4.28310E+01 |
| −4.24560E+00, | −6.43100E−01, | 4.28301E+01 |
| −4.10190E+00, | −1.09490E+00, | 4.28182E+01 |
| −5.17400E−01, | 3.72990E+00, | 4.26439E+01 |
| −6.97500E−01, | 3.27930E+00, | 4.26771E+01 |
| −4.14670E+00, | −4.28300E−01, | 4.28309E+01 |
| −4.25460E+00, | −7.33000E−01, | 4.28288E+01 |
| −3.77020E+00, | −1.81200E−01, | 4.28264E+01 |
| −4.22570E+00, | −5.70100E−01, | 4.28308E+01 |
| −2.93500E−01, | 3.70380E+00, | 4.26524E+01 |
| −3.99970E+00, | −3.02200E−01, | 4.28293E+01 |
| −3.52710E+00, | −9.00000E−02, | 4.28236E+01 |
| −1.99900E−01, | 4.14080E+00, | 4.26153E+01 |
| −3.27400E−01, | 4.20560E+00, | 4.26048E+01 |
| −4.23540E+00, | −6.00300E−01, | 4.28305E+01 |
| −2.08800E−01, | 4.19390E+00, | 4.26097E+01 |
| −7.43000E−01, | 1.43040E+00, | 4.14124E+01 |
| −2.96460E+00, | −1.81920E+00, | 4.13822E+01 |
| −9.52700E−01, | 5.76800E−01, | 4.14297E+01 |
| −1.49440E+00, | −1.10510E+00, | 4.06857E+01 |
| −1.35260E+00, | −6.79200E−01, | 4.14239E+01 |
| −3.37300E+00, | −1.59670E+00, | 4.06694E+01 |
| −1.23840E+00, | −2.33900E−01, | 4.21292E+01 |
| −3.34560E+00, | −1.66570E+00, | 4.20955E+01 |
| −1.78970E+00, | −1.43810E+00, | 4.14024E+01 |
| −1.58650E+00, | −1.04950E+00, | 4.21160E+01 |
| −8.44700E−01, | 1.00280E+00, | 4.14232E+01 |
| −7.66300E−01, | 1.47710E+00, | 4.21099E+01 |
| −3.12890E+00, | −1.75680E+00, | 4.13830E+01 |
| −1.03220E+00, | 1.13400E−01, | 4.07005E+01 |
| −3.22540E+00, | −1.68880E+00, | 4.06657E+01 |
| −2.11860E+00, | −1.72700E+00, | 4.13911E+01 |
| −8.71700E−01, | 1.04610E+00, | 4.21208E+01 |
| −9.83500E−01, | 6.16600E−01, | 4.21276E+01 |
| −3.49660E+00, | −1.57200E+00, | 4.20987E+01 |
| −2.47840E+00, | −1.88180E+00, | 4.06571E+01 |
| −1.10420E+00, | 1.89300E−01, | 4.21304E+01 |
| −3.02090E+00, | −1.80830E+00, | 4.20916E+01 |
| −1.83650E+00, | −1.41560E+00, | 4.21061E+01 |
| −3.43500E+00, | −1.58430E+00, | 4.13869E+01 |
| −1.20030E+00, | −2.66900E−01, | 4.14300E+01 |
| −3.28570E+00, | −1.67720E+00, | 4.13845E+01 |
| −2.90780E+00, | −1.83010E+00, | 4.06595E+01 |
| −1.30750E+00, | −7.12200E−01, | 4.06945E+01 |
| −1.74070E+00, | −1.46300E+00, | 4.06744E+01 |
| −1.54210E+00, | −1.07570E+00, | 4.14143E+01 |
| −9.19300E−01, | 5.33800E−01, | 4.06972E+01 |
| −1.39410E+00, | −6.49600E−01, | 4.21243E+01 |
| −2.58240E+00, | −1.85550E+00, | 4.20921E+01 |
| −6.25200E−01, | 1.80560E+00, | 4.06606E+01 |
| −1.15880E+00, | −3.03100E−01, | 4.06996E+01 |
| −3.07030E+00, | −1.76780E+00, | 4.06623E+01 |
| −2.06860E+00, | −1.74640E+00, | 4.06632E+01 |
| −7.18100E−01, | 1.38060E+00, | 4.06772E+01 |
| −3.18710E+00, | −1.74570E+00, | 4.20933E+01 |
| −2.16720E+00, | −1.70910E+00, | 4.20967E+01 |
| −1.06980E+00, | 1.53000E−01, | 4.14320E+01 |
| −6.65400E−01, | 1.90940E+00, | 4.20948E+01 |
| −6.45900E−01, | 1.85910E+00, | 4.13972E+01 |
| −8.15600E−01, | 9.56500E−01, | 4.06894E+01 |
| −2.53070E+00, | −1.86850E+00, | 4.13843E+01 |
| −1.62790E+00, | 1.16680E+00, | 4.14114E+01 |
| −1.06300E+00, | 2.33860E+00, | 4.20663E+01 |
| −4.26800E−01, | 2.99220E+00, | 4.20382E+01 |
| −4.61500E−01, | 2.71810E+00, | 4.13535E+01 |
| −5.20400E−01, | 2.55880E+00, | 4.20640E+01 |
| −1.19890E+00, | 2.04880E+00, | 4.20803E+01 |
| −3.77770E+00, | −1.35520E+00, | 4.21063E+01 |
| −4.73300E−01, | 2.77550E+00, | 4.20516E+01 |
| −1.49600E+00, | 1.48150E+00, | 4.21030E+01 |
| −5.06600E−01, | 2.50310E+00, | 4.13661E+01 |
| −1.31610E+00, | 1.71700E+00, | 4.13942E+01 |
| −3.64040E+00, | −1.46780E+00, | 4.21023E+01 |
| −1.34260E+00, | 1.76260E+00, | 4.20925E+01 |
| −2.22270E+00, | 4.31000E−01, | 4.14247E+01 |
| −2.00180E+00, | 6.57200E−01, | 4.14221E+01 |
| −2.74760E+00, | 8.22000E−02, | 4.14243E+01 |
| −2.47150E+00, | 2.36000E−01, | 4.14259E+01 |
| −9.16800E−01, | 2.57690E+00, | 4.13540E+01 |
| −1.46600E+00, | 1.43850E+00, | 4.14037E+01 |
| −1.04330E+00, | 2.28730E+00, | 4.13694E+01 |
| −3.90920E+00, | −1.23580E+00, | 4.21102E+01 |
| −2.04320E+00, | 6.93500E−01, | 4.21251E+01 |
| −2.52090E+00, | 2.69000E−01, | 4.21319E+01 |
| −2.26810E+00, | 4.65500E−01, | 4.21292E+01 |
| −5.68100E−01, | 2.34210E+00, | 4.20754E+01 |
| −3.72700E−01, | 3.14790E+00, | 4.13251E+01 |
| −1.66160E+00, | 1.20740E+00, | 4.21119E+01 |
| −2.80060E+00, | 1.13400E−01, | 4.21316E+02 |
| −5.52400E−01, | 2.28830E+00, | 4.13776E+01 |
| −4.16900E−01, | 2.93290E+00, | 4.13399E+01 |
| −1.84260E+00, | 9.43100E−01, | 4.21193E+01 |
| −1.17590E+00, | 2.00030E+00, | 4.13828E+01 |
| −3.80600E−01, | 3.20890E+00, | 4.20236E+01 |
| −1.80510E+00, | 9.04800E−01, | 4.14175E+01 |
| −2.44600E−01, | 3.85940E+00, | 4.19734E+01 |
| −3.70710E+00, | −2.05300E−01, | 4.21275E+01 |
| −1.99500E−01, | 4.10350E+00, | 4.19519E+01 |
| −4.15560E+00, | −5.90500E−01, | 4.21253E+01 |
| −3.05900E−01, | 4.15670E+00, | 4.19429E+01 |
| −3.09950E+00, | −1.90000E−03, | 4.21300E+01 |
| −3.46680E+00, | −1.15900E−01, | 4.21279E+01 |
| −5.07700E−01, | 3.60370E+00, | 4.12848E+01 |
| −6.87800E−01, | 3.22190E+00, | 4.20142E+01 |
| −2.27500E−01, | 4.14960E+00, | 4.19464E+01 |
| −1.99900E−01, | 4.00770E+00, | 4.12550E+01 |
| −6.20500E−01, | 3.30880E+00, | 4.13071E+01 |
| −3.97100E−01, | 3.89920E+00, | 4.12605E+01 |
| −3.98600E−01, | 3.96700E+00, | 4.19583E+01 |
| −4.18280E+00, | −7.96000E−01, | 4.21220E+01 |
| −2.52100E−01, | 4.16190E+00, | 4.19443E+01 |
| −3.34900E−01, | 3.42580E+00, | 4.20080E+01 |
| −3.22170E+00, | −4.05000E−02, | 4.21292E+01 |
| −3.28300E−01, | 4.07070E+00, | 4.12455E+01 |
| −4.16520E+00, | −6.20200E−01, | 4.21249E+01 |
| −4.13760E+00, | −9.66700E−01, | 4.21182E+01 |
| −2.80100E−01, | 4.09540E+00, | 4.12443E+01 |
| −3.29000E−01, | 3.36290E+00, | 4.13093E+01 |
| −3.34450E+00, | −7.77000E−02, | 4.21284E+01 |
| −8.08400E−01, | 2.92570E+00, | 4.20333E+01 |
| −4.11440E+00, | −5.03000E−01, | 4.21262E+01 |
| −9.33200E−01, | 2.63110E+00, | 4.20505E+01 |
| −4.18190E+00, | −7.07000E−01, | 4.21236E+01 |
| −2.09500E−01, | 4.06070E+00, | 4.12496E+01 |
| −2.89600E−01, | 3.64250E+00, | 4.19912E+01 |
| −3.82260E+00, | −2.60700E−01, | 4.21274E+01 |
| −2.52700E−01, | 4.09310E+00, | 4.12453E+01 |
| −4.16520E+00, | −6.20200E−01, | 4.21249E+01 |
| −4.03520E+00, | −4.02600E−01, | 4.21269E+01 |
| −1.99900E−01, | 4.07610E+00, | 4.19546E+01 |
| −3.58800E+00, | −1.57700E−01, | 4.21276E+01 |
| −7.47700E−01, | 3.07360E+00, | 4.20240E+01 |
| −4.14360E+00, | −5.60000E−01, | 4.21256E+01 |
| −6.77900E−01, | 3.16180E+00, | 4.13175E+01 |
| −5.70300E−01, | 3.51930E+00, | 4.19932E+01 |
| −2.85700E−01, | 3.57780E+00, | 4.12924E+01 |
| −3.27800E−01, | 4.14000E+00, | 4.19438E+01 |
| −4.52200E−01, | 3.75140E+00, | 4.12729E+01 |
| −6.28700E−01, | 3.37050E+00, | 4.20039E+01 |
| −2.09100E−01, | 4.12920E+00, | 4.19491E+02 |
| −2.42600E−01, | 3.79280E+00, | 4.12742E+01 |
| −2.79500E−01, | 4.16440E+00, | 4.19430E+01 |
| −7.95300E−01, | 2.86860E+00, | 4.13367E+01 |
| −4.12990E+00, | −5.31000E−01, | 4.21259E+01 |
| −2.52100E−01, | 4.16190E+00, | 4.19443E+01 |
| −1.99700E−01, | 4.03510E+00, | 4.12525E+01 |
| −3.93360E+00, | −3.24900E−01, | 4.21272E+01 |
| −3.42400E−01, | 4.04720E+00, | 4.12475E+01 |
| −4.07810E+00, | −4.50200E−01, | 4.21266E+01 |
| −2.28000E−01, | 4.08100E+00, | 4.12471E+01 |
| −5.63800E−01, | 3.45620E+00, | 4.12962E+01 |
| −3.06600E−01, | 4.08760E+00, | 4.12444E+01 |
| −5.12600E−01, | 3.66840E+00, | 4.19820E+01 |
| −4.55300E−01, | 3.81760E+00, | 4.19703E+01 |
| −4.17540E+00, | −6.62700E−01, | 4.21243E+01 |
| −2.52700E−01, | 4.09310E+00, | 4.12453E+01 |
| −4.03540E+00, | −1.11090E+00, | 4.21142E+01 |
| −7.36200E−01, | 3.01500E+00, | 4.13274E+01 |
| −3.42100E−01, | 4.11650E+00, | 4.19457E+01 |
| −4.16790E+00, | −8.83400E−01, | 4.21201E+01 |
| −4.18440E+00, | −7.51500E−01, | 4.21228E+01 |
| −1.02280E+00, | 2.23370E+00, | 4.06393E+01 |
| −3.57720E+00, | −1.48090E+00, | 4.13898E+01 |
| −2.42210E+00, | 2.03100E−01, | 4.07002E+01 |
| −5.35900E−01, | 2.23120E+00, | 4.06395E+01 |
| −4.92200E−01, | 2.44410E+00, | 4.06272E+01 |
| −2.98630E+00, | −5.93000E−02, | 4.07007E+01 |
| −1.59360E+00, | 1.12500E+00, | 4.06852E+01 |
| −1.15200E+00, | 1.94980E+00, | 4.06540E+01 |
| −3.90040E+00, | −1.14370E+00, | 4.06847E+01 |
| −1.43520E+00, | 1.39390E+00, | 4.06768E+01 |
| −3.84310E+00, | −1.25100E+00, | 4.13961E+01 |
| −3.64820E+00, | −1.38360E+00, | 4.06771E+01 |
| −4.06600E−01, | 2.87000E+00, | 4.05994E+01 |
| −3.22800E−01, | 3.29600E+00, | 4.05671E+01 |
| −3.04280E+00, | −3.09000E−02, | 4.14213E+01 |
| −1.76710E+00, | 8.65600E−01, | 4.06915E+01 |
| −1.28890E+00, | 1.66950E+00, | 4.06665E+01 |
| −8.99800E−01, | 2.52010E+00, | 4.06226E+01 |
| −3.77690E+00, | −1.26640E+00, | 4.06810E+01 |
| −3.51380E+00, | −1.49420E+00, | 4.06733E+01 |
| −2.17700E+00, | 3.96100E−01, | 4.06988E+01 |
| −1.96000E+00, | 6.20300E−01, | 4.06960E+01 |
| −3.64500E−01, | 3.08300E+00, | 4.05838E+01 |
| −2.69460E+00, | 5.14000E−02, | 4.07007E+01 |
| −3.71300E+00, | −1.36930E+00, | 4.13928E+01 |
| −4.49100E−01, | 2.65710E+00, | 4.06139E+01 |
| −4.00210E+00, | −6.01900E−01, | 4.06963E+01 |
| −3.69190E+00, | −3.07600E−01, | 4.06995E+01 |
| −4.02300E+00, | −6.60500E−01, | 4.06954E+01 |
| −7.81800E−01, | 2.80850E+00, | 4.06037E+01 |
| −3.89770E+00, | −4.47500E−01, | 4.06982E+01 |
| −2.10000E−01, | 3.98780E+00, | 4.05049E+01 |
| −3.22550E+00, | −1.31100E−01, | 4.07005E+01 |
| −4.10410E+00, | −6.82500E−01, | 4.14086E+01 |
| −2.80900E−01, | 4.02210E+00, | 4.05015E+01 |
| −3.96790E+00, | −1.12720E+00, | 4.13992E+01 |
| −2.53500E−01, | 4.01990E+00, | 4.05017E+01 |
| −3.86660E+00, | −3.47900E−01, | 4.14134E+01 |
| −5.57100E−01, | 3.38940E+00, | 4.05593E+01 |
| −4.09740E+00, | −9.01000E−01, | 4.14044E+01 |
| −6.12100E−01, | 3.24380E+00, | 4.05712E+01 |
| −5.02800E−01, | 3.53520E+00, | 4.05469E+01 |
| −4.11320E+00, | −7.70400E−01, | 4.14070E+01 |
| −4.05930E+00, | −5.52300E−01, | 4.14107E+01 |
| −2.40600E−01, | 3.72200E+00, | 4.05301E+01 |
| −3.64310E+00, | −2.29600E−01, | 4.14152E+01 |
| −3.16360E+00, | −6.85000E−02, | 4.14199E+01 |
| −4.00840E+00, | −4.72400E−01, | 4.14118E+01 |
| −3.79970E+00, | −3.70600E−01, | 4.06990E+01 |
| −4.08460E+00, | −6.11000E−01, | 4.14098E+01 |
| −4.03300E+00, | −7.02300E−01, | 4.06947E+01 |
| −3.42900E−01, | 3.97350E+00, | 4.05063E+01 |
| −3.40580E+00, | −1.42000E−01, | 4.14172E+01 |
| −4.02690E+00, | −9.18700E−01, | 4.06903E+01 |
| −7.24400E−01, | 2.95330E+00, | 4.05934E+01 |
| −4.04210E+00, | −7.89200E−01, | 4.06931E+01 |
| −3.57930E+00, | −2.53600E−01, | 4.06999E+01 |
| −4.11180E+00, | −8.14400E−01, | 4.14062E+01 |
| −3.07300E−01, | 4.01410E+00, | 4.05023E+01 |
| −3.10570E+00, | −9.59000E−02, | 4.07006E+01 |
| −3.93890E+00, | −4.94400E−01, | 4.06977E+01 |
| −3.34500E+00, | −1.67500E−01, | 4.07004E+01 |
| −3.98880E+00, | −5.73500E−01, | 4.06966E+01 |
| −4.01370E+00, | −6.31500E−01, | 4.06958E+01 |
| −4.11060E+00, | −7.26300E−01, | 4.14078E+01 |
| −2.53500E−01, | 4.01990E+00, | 4.05017E+01 |
| −2.00000E−01, | 3.96230E+00, | 4.05074E+01 |
| −4.09400E+00, | −6.40400E−01, | 4.14093E+01 |
| −4.06790E+00, | −9.83700E−01, | 4.14027E+01 |
| −3.28490E+00, | −1.04700E−01, | 4.14184E+01 |
| −3.95700E−01, | 3.82730E+00, | 4.05203E+01 |
| −4.49000E−01, | 3.68120E+00, | 4.05339E+01 |
| −4.07280E+00, | −5.81000E−01, | 4.14102E+01 |
| −4.09400E+00, | −6.40400E−01, | 4.14093E+01 |
| −2.28700E−01, | 4.00790E+00, | 4.05029E+01 |
| −3.99820E+00, | −1.00070E+00, | 4.06884E+01 |
| −2.81500E−01, | 3.50900E+00, | 4.05491E+01 |
| −4.04410E+00, | −5.24600E−01, | 4.14110E+01 |
| −3.52560E+00, | −1.82800E−01, | 4.14162E+01 |
| −3.75720E+00, | −2.84300E−01, | 4.14143E+01 |
| −4.03950E+00, | −7.45600E−01, | 4.06939E+01 |
| −3.96640E+00, | −4.25100E−01, | 4.14124E+01 |
| −4.02300E+00, | −6.60500E−01, | 4.06954E+01 |
| −2.00000E−01, | 3.93490E+00, | 4.05100E+01 |
| −4.04080E+00, | −8.32800E−01, | 4.06922E+01 |
| −3.97380E+00, | −5.46100E−01, | 4.06970E+01 |
| −3.28900E−01, | 3.99720E+00, | 4.05040E+01 |
| −3.46330E+00, | −2.07500E−01, | 4.07002E+01 |
| −6.67800E−01, | 3.09850E+00, | 4.05826E+01 |

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A nozzle blade for a turbine having an airfoil, the airfoil having an uncoated nominal profile substantially in accordance with Cartesian coordinate values of X, Y and Z set forth in inches in Table I which define a plurality of radially spaced profile sections forming said nominal profile, the Z coordinate values for each profile section being radial distances from the turbine axis to a portion of a surface of revolution about said turbine axis containing the profile section, and the X and Y values for each profile section being coordinate values which, when connected by smooth continuing arcs define the airfoil profile section along said surface of revolution portion, the radially spaced profile sections being joined smoothly with one another to form the nominal airfoil profile.

2. A nozzle blade according to claim 1 forming part of a first stage of a turbine.

3. A nozzle blade for a turbine having an airfoil, the airfoil having a shape in an envelope within ±0.160 inches in a direction normal to any airfoil surface location, the airfoil having an uncoated nominal profile substantially in accordance with Cartesian coordinate values of X, Y and Z set forth in inches in Table I which define a plurality of radially spaced profile sections forming said nominal profile, the Z coordinate values for each profile section being radial distances from the turbine axis to a portion of a surface of revolution about said turbine axis containing the profile section, and the X and Y values for each profile section being coordinate values which, when connected by smooth continuing arcs define the airfoil profile section along said surface of revolution portion, the radially spaced profile sections being joined smoothly with one another to form the nominal airfoil profile.

4. A nozzle blade according to claim 3 forming part of a first stage of a turbine.

5. A turbine having a plurality of nozzle blades forming a portion of a turbine stage, each said nozzle blade being in the shape of an airfoil, each airfoil having an uncoated nominal profile substantially in accordance with Cartesian coordinate values of X, Y and Z set forth in inches in Table I which define a plurality of radially spaced profile sections forming said nominal profile, the Z coordinate values for each profile section being radial distances from the turbine axis to a portion of a surface of revolution about said turbine axis containing the profile section, and the X and Y values for each profile section being coordinate values which, when connected by smooth continuing arcs define the airfoil profile section along said surface of revolution portion, the radially spaced profile sections being joined smoothly with one another to form the nominal airfoil profile.

6. A turbine according to claim 5 wherein said nozzle blades form part of a first stage of the turbine.

7. A turbine having a plurality of nozzle blades forming a portion of a turbine stage, each said nozzle blade being in the shape of an airfoil, each said airfoil having an uncoated nominal profile substantially in accordance with Cartesian coordinate values of X, Y and Z set forth in inches in Table I which define a plurality of radially spaced profile sections forming said nominal profile, the Z coordinate values for each profile section being radial distances from the turbine axis to a portion of a surface of revolution about said turbine axis containing the profile section, and the X and Y values for each profile section being coordinate values which, when connected by smooth continuing arcs define the airfoil profile section along said surface of revolution portion, the radially spaced profile sections being joined smoothly with one another to form the nominal airfoil profile, each said airfoil having a shape within ±0.0160 inches in a direction normal to any airfoil surface location.

8. A turbine according to claim 7 wherein said nozzle blades form part of a first stage of a turbine.

9. A turbine according to claim 7 wherein each said airfoil forms part of a nozzle segment containing said airfoil and inner and outer sidewalls.
